(19) United States
(12) Patent Application Publication
(10) Pub. No.: US 2024/0040489 A1
(43) Pub. Date: Feb. 1, 2024

(54) SYSTEMS AND METHODS FOR REDUCING POWER CONSUMPTION THROUGH WIFI SCAN OPTIMIZATIONS

(71) Applicant: META PLATFORMS, INC., Menlo Park, CA (US)

(72) Inventor: Siddharth Ray, Sunnyvale, CA (US)

(21) Appl. No.: 18/227,174

(22) Filed: Jul. 27, 2023

Related U.S. Application Data
(60) Provisional application No. 63/369,791, filed on Jul. 29, 2022.

(51) Int. Cl. H04W 48/16; H04W 52/02; H04W 64/00

(52) U.S. Cl. CPC H04W 48/16; H04W 52/0241; H04W 64/00

(57) ABSTRACT

A method and system for wireless scanning with a device is provided. The method and system may include determining that the device is disconnected from a wireless access point (WAP) or from a companion device. The method and system may, determine at least one condition associated with the device, based on determining that the device is disconnected from the WAP or from the companion device. The method and system may determine that the at least one condition satisfies a trigger condition. The method and system may enable scanning, by the device, to detect the WAP or the companion device at a non-standard frequency, based on the at least one condition satisfying the trigger condition. The non-standard frequency may be less frequent than a standard frequency.

### CROSS-REFERENCE TO RELATED APPLICATIONS

This application is a Non-Provisional Application of U.S. Provisional Application No. 63/369,791 filed Jul. 29, 2022, entitled “Systems And Methods For Reducing Power Consumption Through Will Scan Optimizations,” the entire contents of which are incorporated in their entirety herein by reference.

### TECHNICAL FIELD

Exemplary embodiments of this disclosure relate generally to systems and methods for providing Wi-Fi scan power optimization for a wearable smart device or other applications.

### BACKGROUND

Artificial reality is a form of reality that has been adjusted in some manner before presentation to a user, which may include, for example, a virtual reality, an augmented reality, a mixed reality, a hybrid reality, or some combination or derivative thereof. Head-mounted displays (HMDs) including one or more near-eye displays may often be used to present visual content to a user for use in artificial reality applications.

HMDs and other wearable devices may connect to a network (e.g., the Internet) with or without a companion phone, watch, or other device. When not associated with a wireless connection, an HMD may perform regular scans in order to detect one or more access points (e.g., Wi-Fi access points). Regular scans may rapidly drain the battery power of the HMD.

### BRIEF SUMMARY

Disclosed herein are systems and methods for Wi-Fi scan power optimizations.

In one aspect of the present disclosure, a method for wireless scanning with a device is provided. The method may include determining that the device is disconnected from a wireless access point (WAP) or from a companion device. The method may further include determining at least one condition associated with the device, based on the determining that the device is disconnected from the WAP or from the companion device. The method may further include determining that the at least one condition satisfies a trigger condition. The method may further include scanning, by the device, to detect the WAP or the companion device at a non-standard frequency, based on the at least one condition satisfying the trigger condition. The non-standard frequency may be less frequent than a standard frequency.

In another aspect of the present disclosure, a method facilitating wireless scanning with a first device is provided. The method may include connecting the first device to a companion device. The method may further include determining the first device is disconnected from a wireless access point. The method may further include determining at least one condition associated with the first device or with the companion device, based on the determining that the first device is disconnected from the wireless access point. The method may further include determining that the at least one condition satisfies a trigger condition. The method may further include scanning, by the first device, to detect the wireless access point at a non-standard frequency, based on the at least one condition satisfying the trigger condition. The non-standard frequency may be less frequent than a standard frequency.

In another aspect of the present disclosure, an apparatus for wireless scanning is provided. The apparatus may include one or more processors and a memory including computer program code instructions. The memory and computer program code instructions are configured to, with at least one of the processors, cause the apparatus to at least perform operations including determining that the apparatus is disconnected from a wireless access point or from a companion device. The memory and computer program code are also configured to, with at least one of the processors, cause the apparatus to determine at least one condition associated with the apparatus, based on the determining that the apparatus is disconnected from the wireless access point or from the companion device. The memory and computer program code are also configured to, with at least one of the processors, cause the apparatus to determine that the at least one condition satisfies a trigger condition. The memory and computer program code are also configured to, with at least one of the processors, cause the apparatus to scan to detect the wireless access point or the companion device at a non-standard frequency, based on the at least one condition satisfying the trigger condition. The non-standard frequency may be less frequent than a standard frequency.

In yet another aspect of the present disclosure, a computer program product for wireless scanning with a device is provided. The computer program product includes at least one computer-readable storage medium having computer-executable program code instructions stored therein. The computer-executable program code instructions may include program code instructions configured to determine that the device is disconnected from a wireless access point or from a companion device. The computer program product may further include program code instructions configured to determine at least one condition associated with the device, based on the determining that the device is disconnected from the wireless access point or from the companion device. The computer program product may further include program code instructions configured to determine that the at least one condition satisfies a trigger condition. The computer program product may further include program code instructions configured to scan, by the device, to detect the wireless access point or the companion device at a non-standard frequency, based on the at least one condition satisfying the trigger condition. The non-standard frequency may be less frequent than a standard frequency.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates an example head-mounted display.

FIG. 2 is a flowchart of an exemplary method for power optimization of a device, according to techniques disclosed herein.

FIG. 3 is a flowchart of an exemplary method for power optimization of a device connected to a companion device, according to techniques disclosed herein.

FIG. 4 is an exemplary block diagram of a device.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

The present disclosure is generally directed to systems and methods for reducing power consumption and increasing battery life in a HMD or other device. For example, the systems or methods may alter or adjust the frequency of performing scans (e.g., reduce the number of scans per a period of time), which may preserve battery life.

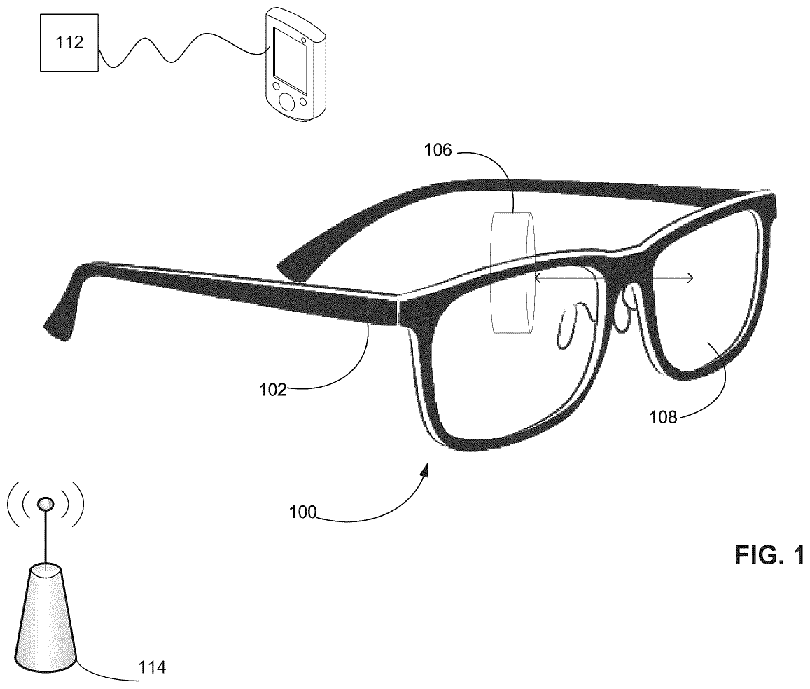

FIG. 1 illustrates an example HMD 100 including one or more near-eye displays. HMD 100 may be used to present visual content to a user, for example during use of artificial reality applications. Although HMD 100 may be used in the examples herein, it is contemplated that individual subcomponents of HMD 100 (e.g., a power source such as a battery), peripherals for HMD 100 (e.g., controllers), or hardware not related to HMD 100 may implement the disclosed power preservation system.

HMDs 100, such as smart glasses, may communicate with a network device (e.g., Internet devices). This communication may be through an association with a wireless network, established through a Wi-Fi router, by a Wi-Fi access point (AP), or another type of wireless access point (WAP) 114. This association may allow the HMD 100 to send or receive media or other files from a network device (e.g., WAP 114). In addition, the HMD 100 may communicate while linked with a companion device 112, such as, for example, a phone or a watch. The companion device may act as a hot spot for connection to a WAP 114.

To associate with a WAP 114 or with a companion device, the HMD 100 may perform regular scans to detect an AP to associate with. These scans may be automatic and therefore may not require input from a user. The scans may be performed at a user defined frequency. Scanning may be triggered by a user sharing a media file or taking some other action on the HMD 100 that may require or otherwise use Wi-Fi or other wireless communication.

The downside of having to perform scans to find a WAP 114 with which to associate is the impact on battery life of the HMD 100. Performing scans is expensive from a device battery perspective. By decreasing or limiting the amount of scans HMD 100 performs, HMD 100 may retain battery life for a longer period of time. Battery life may also be retained if the frequency of scanning is altered, from a standard frequency of scanning to a non-standard, reduced frequency. For example, the scanning, by the HMD 100, to detect a WAP(s) at the non-standard frequency may be less frequent than the standard frequency which may cause the HMD 100 to utilize less power when scanning at the non-standard frequency than an instance in which the HMD 100 scans to detect a WAP(s) at the standard frequency. For purposes of illustration and not of limitation, in some examples, the standard frequency may be one scan, by the HMD to detect a WAP(s), per one (1) minute. Additionally for purposes of illustration and not of limitation in some examples, the non-standard frequency may be one scan, by the HMD to detect a WAP(s), per five (5) minutes.

In some other examples, a device (e.g., HMD 100) may reduce the range of radio frequencies the device scans over to help reduce battery life impact associated with the device. For instance, the range of radio frequencies may be associated with one or more bands (e.g., including a range of frequencies) for scanning by the device (e.g., device 100). In this regard, for purposes of illustration and not of limitation, for example, the standard scanning frequencies may be the 2.4 Gigahertz (GHz), 5 GHz and 6 GHz WLAN channels. In some examples, the non-standard scanning frequenc(ies) may be 2.4 GHz. In this manner, the device (e.g., HMD 100) may utilize the standard scanning frequencies to scan each (e.g., all) the channels in the 2.4G band (e.g., frequency band (e.g., GHz)), 5G band and 6G band. In some other alternative examples, the device (e.g., HMD 100) may utilize the standard scanning frequencies to scan a subset of the channels in the 2.4G band, 5G band and 6G band. The device may utilize the non-standard frequenc(ies) to scan one or more of the channels, or each of the channels, in the 2.4G band. The use of the reduced non-standard scanning frequenc(ies) may help save/conserve a battery (e.g., battery power) associated with the device (e.g., HMD 100).

HMD 100 may include enclosure 102 (e.g., an eyeglass frame) or a waveguide 108. Waveguide 108 may be configured to direct images to the user's eye. In some examples, HMD 100 may be implemented in the form of augmented-reality glasses. Accordingly, the waveguide 108 may be at least partially transparent to visible light to allow the user to view a real-world environment through waveguide 108. FIG. 1 also shows a representation of an eye 106 that may be real or an artificial eye-like object for testing or using HMD 100. Companion device 112 may be configured to connect with HMD 100 via wired or wireless communication. WAP 114 may be communicatively connected with HMD 100 and/or companion device 112.

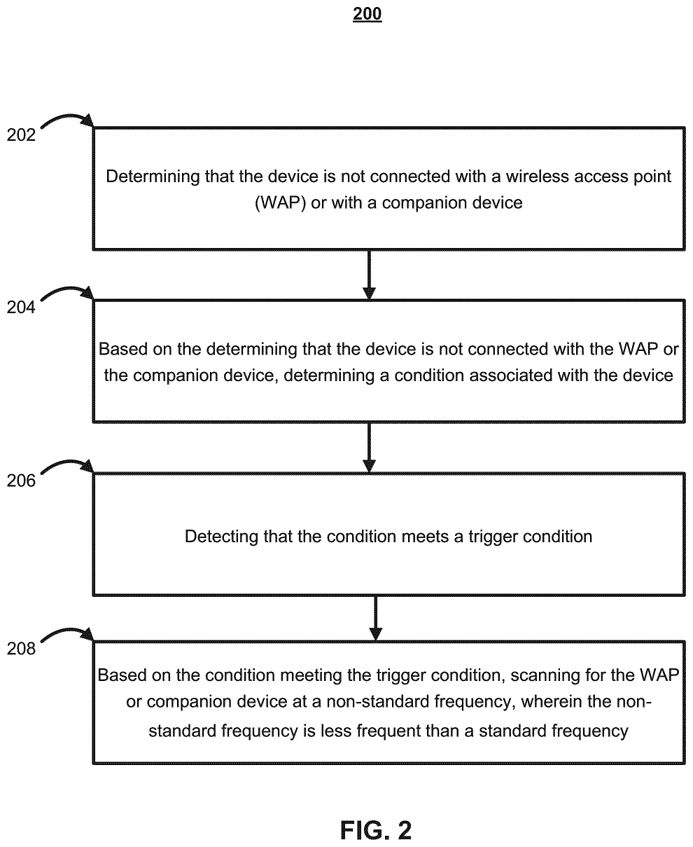

FIG. 2 is a flowchart of an exemplary method for power optimization of a device, according to techniques disclosed herein. For example, exemplary method 200 (e.g., steps 202-208) may be performed by a device, such as HMD 100, automatically or in response to a request from a user. In the exemplary embodiment described below, method 200 is used in conjunction with HMD 100. It is contemplated that method 200 may be used with any other suitable device.

Exemplary method 200 may include one or more of the steps below. In step 202, the method may include determining that HMD 100 is not connected with a Wi-Fi access point (e.g., WAP 114) or with a companion device 112. The determination may be made by observing a device setting (e.g., Wi-Fi enablement is turned off), HMD 100 not detecting connection to a WAP, HMD 100 detecting connection to a WAP but no connection to the Internet, or other suitable ways. The WAP 114 may be a known WAP that the device is generally connected to, such as a home router or work network, or may be any other WAP that is accessible to the device. The companion device 112 may comprise any device that the HMD 100 is able to communicate with, and may include a wearable device such as, for example, a smart watch, a mobile device like a smart phone, or any other device suitable for communication.

Additionally, when not connected to WAP 114, HMD 100 may perform scans for a WAP 114 at a standard frequency (e.g., one scan, by HMD 100 to detect a WAP(s), per minute, etc.), predetermined by the HMD 100's operating system. The scan may be done automatically by HMD 100 when the HMD 100 is not connected to a network or companion device 112. Alternatively, the scan may be triggered by user action, such as when a user attempts to send a media file to an Internet device, for example. In this case, the attempt to send the file may cause HMD 100 to scan for a WAP to send the file more easily. The scan may be performed at a standard frequency predetermined by the HMD 100's software settings.

In step 204, the method may include, based on the determining that HMD 100 is not connected with the WAP 114 or the companion device 112, determining a condition associated with HMD 100. Applicable conditions may include, but are not limited to, the conditions herein. The appliable conditions may also be referred to herein as trigger conditions.

One applicable condition is that HMD 100 has been stationary for a threshold period of time. In this context, “stationary” may be determined by HMD 100's global positioning system (GPS) status or other sensor status (e.g., accelerometers or gyroscopes), the HMD 100's presence within a specific geofence, or any other suitable method. For example, the condition may be based on the HMD 100 being determined (e.g., by the GPS) as being stationary within an area defined by the geofence. The time period may be preprogrammed by an HMD 100, where a threshold time (e.g., a predetermined threshold period of time) is passed to determine that the HMD 100 is stationary. The HMD 100 settings may include specific values for this threshold period of time (e.g., 10 minutes, etc.) and the amount of movement permitted (e.g., a threshold distance (e.g., 50 meters (m), etc.)) by HMD 100 to determine whether or not HMD 100 is “stationary.” For example, a HMD 100 may be stationary based on being on a surface and not providing an indication of movement.

A second applicable condition may be the presence of HMD 100 within a location known to lack Wi-Fi coverage (e.g., a WAP), or access to the network (e.g., WAP 114) is prohibited to HMD 100. Location may be determined by the location services of HMD 100's settings, a location signature, GPS, or any other suitable method thereof. Locations known to lack Wi-Fi coverage may include outdoor parks, remote rural areas, etc. Alternatively, the location may have Wi-Fi coverage, but the user is unable to connect to the network. This includes cases where the network is private, or the enterprise is not associated with the user. Additionally, the user may have selected to use HMD 100 without Wi-Fi while in the location (e.g., a public network is available but unreliable, or the connection is weak).

A third condition may be a time of day when the HMD 100 is not expected to be near a WAP 114 or moving at a threshold speed. In some examples, the threshold speed in which the HMD 100 may be moving at may be 15 miles per hour (mph). In other examples, the threshold speed in which the HMD 100 may be moving at may be other suitable speeds (e.g., 12 mph, etc.). For example, a user commutes to work from 8 AM to 9 AM every weekday. In this case, scanning frequency by an HMD 100 to detect a WAP 114 may be altered or adjusted during the commuting time, as the HMD 100 may not need Wi-Fi connection while commuting (e.g., applications on HMD 100 may not be used), or is in a state of motion (e.g., HMD 100 is moving at a high speed (e.g., greater than 15 mph, etc.) where establishing a Wi-Fi connection is impractical (e.g., historical attempts to connect to WAP 114 for only a 10 second interval or otherwise brief connections). In this regard, the HMD 100 may determine that one or more historical attempts, by the HMD 100, to connect to the WAP 114 or one or more other WAPs 114 were associated with connections to the WAP 114 or the one or more WAPs 114 for a time period equal to or below a predetermined time period (e.g., 10 seconds or less, 5 seconds or less, etc.). HMD 100 may identify time periods where the user is not near, or lacks access to, a WAP(s) 114 based on usage patterns over time associated with the HMD 100. Alternatively, the user may indicate on HMD 100's settings when a commute (or other time period where association with a WAP 114 is not desired) may occur. HMD 100 may correlate these identified time periods to periods of lower scanning frequencies.

A fourth applicable condition may be when a device power source is at a threshold power level or at a threshold thermal limit. For example, if the battery level of HMD 100 is sufficiently low, it may not be economical to continue using battery power to scan for a WAP 114. Sufficiently low battery levels may be equal to or less than 15% (e.g., a predetermined threshold power level), for example. Scanning frequency may further be reduced, by the HMD 100, when a thermal limit of HMD 100 is reached. In some examples, the thermal limit of the HMD 100 may be a temperature limit of 50° C. In other examples, the thermal limit of the HMD 100 may be other temperature limits (e.g., 40° C., 45° C., etc.). If HMD 100 is overheating, reducing the scanning frequency may help to decrease a load on the power source (e.g., battery) so that HMD 100 is able to cool down. Thermal limits may be determined by the temperature of the HMD 100 as measured by sensors of HMD 100. The temperature may be internal to HMD 100 or an external reading. If the HMD 100 is otherwise exposed to a catastrophic situation, such as extreme cold or water, the frequency of Wi-Fi scans may be decreased (e.g., Wi-Fi scans decreased from the standard frequency to the non-standard frequency).

In step 206, the method may include detecting the condition(s) is outside of a predetermined threshold (e.g., meets/satisfies a trigger condition). This determination may be made by HMD 100, based on specific preprogrammed circumstances for HMD 100. As illustrated herein, the condition(s) may be detected by a GPS location (e.g., HMD 100 is in a location known to lack a WAP), an internal sensor on HMD 100 such as a thermometer or accelerometer, or may be based on the system settings for HMD 100. The predetermined threshold may correspond to the condition, for example in an instance in which the determined condition(s) is the temperature of HMD 100, the predetermined threshold may be the upper limit of an internal temperature (e.g., 50° C., etc.) before HMD 100 enters a thermal state. The predetermined threshold may also comprise a time or a number of detected WAPs.

In step 208, once the trigger condition for reducing the scanning frequency has been determined, the method may include reducing the standard frequency of the regular scan by the HMD 100. In this regard, in step 208 the HMD 100 may, based on a condition(s) meeting/satisfying a trigger condition, scan for a WAP(s) or a companion device(s) at a non-standard frequency, in which the non-standard frequency is less frequent than a standard frequency. The device (e.g., HMD 100) may do this autonomously without the interference of another system. The determined reduction of the scanning frequency may be based on a calculated display lag or other performance parameter, in order to minimize any impact that may be perceived by the user and effect the user experience. As described above, in some examples, the scanning, by the HMD 100, to detect a WAP(s) at the non-standard frequency may be less frequent than the standard frequency which may cause the HMD 100 when scanning at the non-standard frequency to utilize less power than an instance in which the HMD 100 scans to detect a WAP(s) (e.g., WAPs 114) at the standard frequency.

In each of the illustrated exemplary conditions, user action is not required and the process to reduce the rate of scans may be automatically done by the device (e.g., HMD 100). However, a user may trigger these conditions based on usage or external factors such as, for example, movement or location. Reduced scanning frequency may be undetected by the user, but may result in a slower rate or lag in transferring media files or streaming content, for example. Another example of a condition (e.g., a trigger condition) may be based on the HMD 100 evaluating a connection(s) of the HMD 100 to the WAP 114 or one or more other WAPs 114 having a signal strength (e.g., received signal strength indicator (RSSI)) below a predetermined threshold signal strength during a time period associated with a historical time period (e.g., 8 AM to 9 AM every weekday, etc.). The exemplary conditions are not exhaustive, and other circumstances may apply where reducing the frequency of scans is practical or necessary.

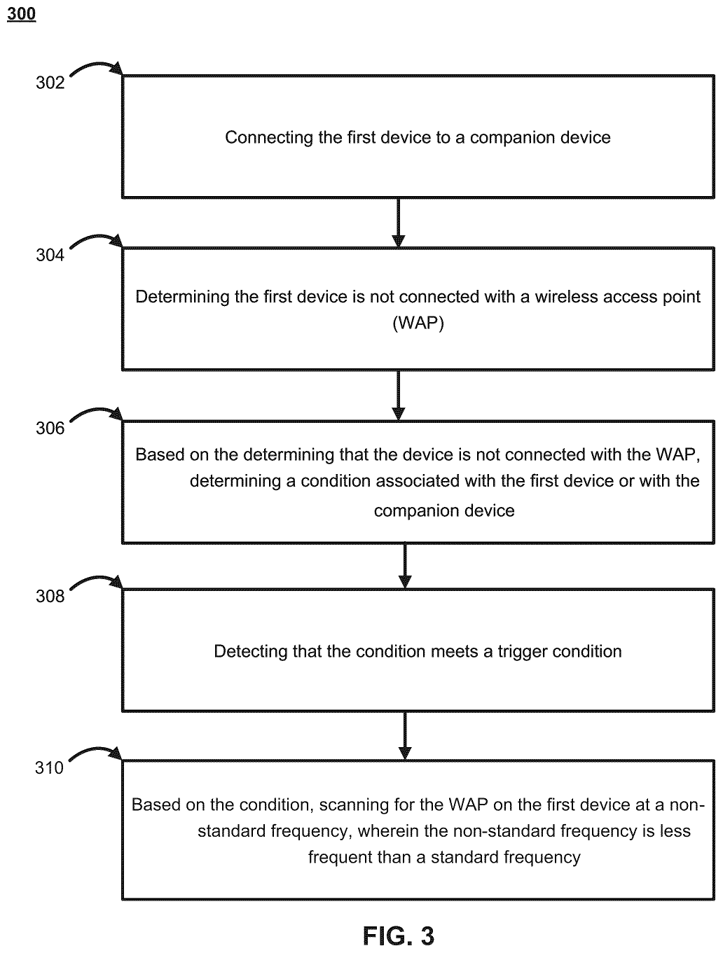

FIG. 3 is a flowchart of an exemplary method for power optimization of a device connected to a companion device, according to techniques disclosed herein. For example, exemplary method 300 (e.g., steps 302-310) may be performed by a device, such as HMD 100, or a companion device, such as companion device 112, automatically or in response to a request from a user.

In step 302, the method may include connecting a first device (e.g., HMD 100) with a companion device. The companion device may comprise any device that the HMD 100 is able to communicate with, and may include a wearable device such as, for example, a smart watch, a mobile device like a smart phone, or any other device suitable for communication. HMD 100 may connect with companion device 112 using Wi-Fi, Bluetooth, or another wireless communication technology. Companion device 112 may be configured to operate as a repeater or WAP, among other things. The connection between the HMD 100 and the companion device may be set by the user, but it is contemplated that the HMD 100 and companion device 112 may automatically connect as well. However, contexts and conditions such that the device (e.g., HMD 100) may not associate with the WAP may apply, such that the device still scans for one or more available WAPs.

In step 304, the method may include determining that the first device associated with a companion device is not associated with a WAP (e.g., WAP 114). The determination may be made by HMD 100 not detecting connection to a WAP 114, HMD 100 detecting connection to a WAP 114 but no connection to the Internet, or other suitable ways. The WAP 144 may be a known WAP that HMD 100 is generally connected to, such as for example a home router or work network, or may be any other WAP that is accessible to the device. The companion device 112 may comprise any device that the HMD 100 is able to communicate with, and may include a wearable device such as, for example, a smart watch, a mobile device like a smart phone, or any other device suitable for communication. Generally, the connection between the first device, for example HMD 100, and the companion device 112, may be set by the user, but it is contemplated that the HMD 100 and companion device 112 may automatically connect as well without user action.

Additionally, when not connected to WAP 114, HMD 100 or companion device 112 may perform scans for a WAP 114 at a standard frequency, predetermined by the HMD 100's operating system. The scan may be done automatically by HMD 100 or companion device 112 when HMD 100 is not connected to a network (e.g., WAP 114) or companion device 112. Alternatively, the scan may be triggered by user action, such as when a user attempts to send a media file to an Internet device, or between local network devices, for example. In this case, the attempt to send the file may cause HMD 100 or companion device 112 to scan for a WAP 114 to send the file more easily. The scan may be performed at a standard frequency predetermined by software settings.

In step 306, the method may include, based on the determining that HMD 100 is not connected with the WAP 114, determining a condition(s) associated with the first device or the companion device 112. Applicable conditions may include, but are not limited to, the conditions herein.

In step 308, the method may include detecting the condition(s) meets a trigger condition. This detection may be made by HMD 100, based on specific preprogrammed circumstances for HMD 100, or may be made by companion device 112 based on information from HMD 100. As illustrated herein, the trigger condition may be detected by a GPS location (i.e., HMD 100 is in a location known to lack a WAP), an internal sensor(s) on HMD 100 such as, for example, a thermometer or accelerometer, or may be based on the system settings for HMD 100. The threshold may correspond to the condition(s), for example in an instance in which the determined condition is the temperature of HMD 100, the threshold may be the upper limit of an internal temperature before HMD 100 enters a thermal state. The threshold may also comprise a time, or a number of detected WAPs.

One trigger condition is that HMD 100 or companion device 112 has been stationary for a threshold period of time. In this context, “stationary” may be determined by either HMD 100's or companion device 112's GPS status or other sensor status (e.g., accelerometers or gyroscopes), either device's presence within a specific geofence, or any other suitable method. The time period may be preprogrammed by HMD 100 or companion device 112, where a threshold time is passed to determine that HMD 100 is stationary. The device settings may include specific values for this threshold period of time and the amount of movement permitted (e.g., a threshold distance (e.g., 50 m, etc.)) by HMD 100 to determine whether or not HMD 100 is “stationary”. For example, HMD 100 or companion device 112 may be stationary based on being on a surface and not providing an indication of movement. Companion device 112 may be determined to be stationary while HMD 100 is moving, or HMD 100 may be stationary while companion device 112 is moving.

A second trigger condition may be the presence of HMD 100 or companion device 112 within a location known/determined to lack, or have no, Wi-Fi coverage (e.g., a WAP), or access to the network is prohibited to HMD 100 or companion device 112. For example, the trigger condition may be based on the HMD 100, or the companion device 112, being in a location known/determined to have a prohibited WAP(s). In this regard, the HMD 100 may perform a scan to detect the prohibited WAP(s). In this example, even though the HMD 100 may detect the prohibited WAP(s) based on the scan, the prohibited WAP(s) may disallow/prohibit the HMD 100 to connect to the prohibited WAP(s). Location may be determined by the location services of either HMD 100's or companion device 112's settings, a location signature, GPS, or any other suitable method thereof. Locations known/determined to lack Wi-Fi coverage, or have no/lack a WAP(s) may include outdoor parks, remote rural areas, etc. Alternatively, the location may have Wi-Fi coverage, or have a WAP(s), but the user is unable to connect their devices to the network (e.g., or to a WAP(s)). This includes cases where the network is private, or the enterprise is not associated with the user. Additionally, the user may have selected to use HMD 100 or companion device 112 without Wi-Fi while in the location (e.g., a public network is available but unreliable, or the connection is weak).

A third trigger condition may be a time of day when HMD 100 or companion device 112 is not expected to be near a WAP 114 or moving at a threshold speed. For example, a user commutes to work from 8 AM to 9 AM every weekday. In this case, scanning frequency of WAP 114 may be altered during the commuting time, as the HMD 100 or companion device 112 does not need Wi-Fi connection while commuting (e.g., applications on HMD 100 are not used), or is in a state of motion where establishing a Wi-Fi connection is impractical (e.g., historical attempts to connect to WAP 114 for only a 10 second interval or otherwise brief connections). HMD 100 or companion device 112 may identify time periods where the user is not near a WAP 114 based on usage patterns over time. Alternatively, the user may indicate on HMD 100's or companion device 112's settings when a commute (or other time period where association with a WAP 114 is not desired) may occur. HMD 100 or companion device 112 may correlate these identified time periods to periods of lower scanning frequencies.

A fourth trigger condition may be when a device power source is at a threshold power level or at a threshold thermal limit. For example, if the battery level of HMD 100 is sufficiently low, it may not be economical to continue using battery power to scan for a WAP 114. Sufficiently low battery levels may be less than 15%, for example. Scanning frequency may further be reduced when a thermal limit of HMD 100 is reached. If HMD 100 is overheating, reducing the scanning frequency may help to decrease a load on the power source (battery) so that HMD 100 is able to cool down. Thermal limits may be determined by the temperature of the device (e.g., HMD 100) as measured by device sensors. The temperature may be internal to HMD 100, or an external reading. If HMD 100 is otherwise exposed to a catastrophic situation, such as extreme cold or water, the frequency of Wi-Fi scans may be decreased.

Alternatively, each of the illustrated exemplary conditions may apply to the companion device. For example, if the companion device (e.g., companion device 112) is known to be stationary for a period of time, scans may be reduced in both the first device (e.g., HMD 100) and the companion device (e.g., companion device 112) in order to conserve battery life in each device. The same may apply for location and time based conditions, where if the condition is met for one device, it likely applies to the second device as well (i.e., if the first device is in a location known to have no Wi-Fi coverage, it is assumed that the companion device is in the same general location). It may be advantageous for the scanning frequency in the companion device to be decreased in tandem with the scanning frequency of the first device, so that power is optimized for each. Further, it is considered that the companion device may benefit from a reduced scanning frequency.

In step 310, once the applicable condition for reducing the scanning frequency has been determined, the method may include reducing the standard frequency of the scan. The companion device 112 may communicate this to the first device autonomously without the user taking any action. In this regard, in step 310 the HMD 100 may, based on a condition(s), scan for a WAP at a non-standard frequency, in which the non-standard frequency is less frequent than a standard frequency.

In each of the illustrated exemplary conditions, user action may not be required and the process to reduce the rate of scans may be automatically communicated by the companion device 112 to the HMD 100. However, a user may trigger these conditions based on usage or external factors such as movement or location of companion device 112 to the HMD 100. The exemplary list of conditions are not exhaustive, and other circumstances may apply where reducing the frequency of scans is practical or necessary. For instance, another example of a condition associated with reducing the scanning frequency may be based on a current time (e.g., 8:30 AM) being within a historical period of time (e.g., 8 AM to 9 AM, etc.) for a threshold time period (e.g., 10 seconds or less, 5 seconds or less, 0 seconds, etc.). In some other examples, a condition associated with reducing the scanning frequency may be associated with one or more types of connection(s) by the HMD 100 to one or more WAPs (e.g., WAPs 114). For example, the types of connections may be associated with a threshold number of errors associated with the connections. The one or more types of connections may cause a condition(s) based on being determined to have a threshold signal strength (e.g., a predetermined threshold RSSI). For instance, in some examples, a type(s) of connection(s) having a signal strength equaling, or being below, a predetermined threshold signal strength may indicate to a device (e.g., HMD 100, companion device 112) an unreliable connection to a WAP (e.g., WAP 114).

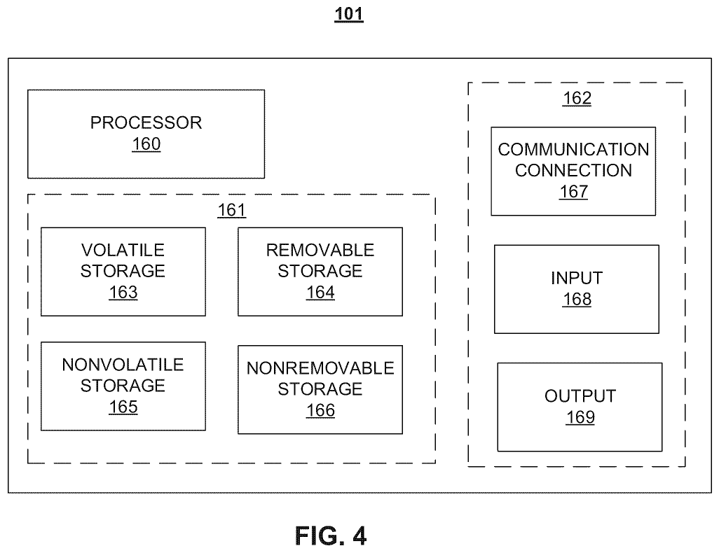

FIG. 4 is an exemplary block diagram of a device, such as for example HMD 100, companion device 112, WAP 114 or another device 101. In an example, HMD 100, companion device 112, WAP 114 or another device 101 may include hardware or a combination of hardware and software. The functionality to facilitate telecommunications via a telecommunications network may reside in one or combination of devices. A device may represent or perform functionality of one or more devices, such as a component or various components of a cellular broadcast system wireless network, a processor, a server, a gateway, a node, a gaming device, or the like, or any appropriate combination thereof. It is emphasized that the block diagram depicted in FIG. 4 is exemplary and not intended to imply a limitation to a specific implementation or configuration. Thus, HMD 100, companion device 112, WAP 114 or another device 101 for example, may be implemented in a single device or multiple devices (e.g., single server or multiple servers, single gateway or multiple gateways, or single controller or multiple controllers). Multiple network entities may be distributed or centrally located. Multiple network entities may communicate wirelessly, via hardwire, or any appropriate combination thereof.

HMD 100, companion device 112, WAP 114 or another device 101 may comprise a processor 160 or a memory 161, in which the memory may be coupled with processor 160. Memory 161 may contain executable instructions that, when executed by processor 160, cause processor 160 to effectuate operations associated with the power optimization system, or other subject matter disclosed herein.

In addition to processor 160 and memory 161, HMD 100, companion device 112, WAP 114 or another device 101 may include an input/output system 162. Processor 160, memory 161, or input/output system 162 may be coupled together (coupling not shown in FIG. 4) to allow communications between them. Each portion of HMD 100, companion device 112, WAP 114 or another device 101 may include circuitry for performing functions associated with each respective portion. Thus, each portion may include hardware, or a combination of hardware and software. Input/output system 162 may be capable of receiving or providing information from or to a communications device or other network entities configured for telecommunications. For example, input/output system 162 may include a wireless communication (e.g., Wi-Fi, Bluetooth, or 5G) card. Input/output system 162 may be capable of receiving or sending video information, audio information, control information, image information, data, or any combination thereof. Input/output system 162 may be capable of transferring information with HMD 100, companion device 112, WAP 114 or another device 101. In various configurations, input/output system 162 may receive or provide information via any appropriate manner, such as, for example, optical (e.g., infrared), electromagnetic (e.g., radio frequency (RF), Wi-Fi, Bluetooth), acoustic (e.g., speaker, microphone, ultrasonic receiver, ultrasonic transmitter), or a combination thereof. In an example configuration, input/output system 162 may comprise a Wi-Fi finder, a two-way GPS chipset or equivalent, or the like, or a combination thereof.

Input/output system 162 of HMD 100, companion device 112, WAP 114 or another device 101 also may include a communication connection 167 that allows HMD 100, companion device 112, WAP 114 or another device 101 to communicate with other devices, network entities, or the like. Communication connection 167 may comprise communication media. Communication media typically may embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 162 also may include an input device 168 such as keyboard, mouse, pen, voice input device, or touch input device. Input/output system 162 may also include an output device 169, such as a display, speakers, or a printer.

Processor 160 may be capable of performing functions associated with telecommunications, such as functions for processing broadcast messages, as described herein. For example, processor 160 may be capable of, in conjunction with any other portion of HMD 100, companion device 112, WAP 114 or another device 101, determining a type of broadcast message and acting according to the broadcast message type or content, as described herein.

Memory 161 of HMD 100, companion device 112, WAP 114 or another device 101 may comprise a storage medium having a concrete, tangible, physical structure. In some examples, the memory 161 may include a volatile storage 163, a removable storage 164, a nonvolatile storage 165 and a nonremovable storage 166. As is known, a signal does not have a concrete, tangible, physical structure. Memory 161, as well as any computer-readable storage medium described herein, is not to be construed as a signal. Memory 161, as well as any computer-readable storage medium described herein, is not to be construed as a transient signal. Memory 161, as well as any computer-readable storage medium described herein, is not to be construed as a propagating signal. Memory 161, as well as any computer-readable storage medium described herein, is to be construed as an article of manufacture.

Herein, a computer-readable storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable storage medium may be volatile, non-volatile, or a combination of volatile and non-volatile, where appropriate.

While the disclosed systems have been described in connection with the various examples of the various figures, it is to be understood that other similar implementations may be used or modifications and additions may be made to the described examples of a power optimization system, among other things as disclosed herein. For example, one skilled in the art will recognize that a power optimization system, among other things as disclosed herein in the instant application may apply to any environment, whether wired or wireless, and may be applied to any number of such devices. Therefore, the disclosed systems as described herein should not be limited to any single example, but rather should be construed in breadth and scope in accordance with the appended claims.

In describing preferred methods, systems, or apparatuses of the subject matter of the present disclosure, the power optimization as illustrated in the Figures, and the specific terminology is employed for the sake of clarity. The claimed subject matter, however, is not intended to be limited to the specific terminology so selected.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method facilitating wireless scanning with a device, the method comprising:
determining that the device is disconnected from a wireless access point (WAP) or from a companion device;
determining at least one condition associated with the device, based on the determining that the device is disconnected from the WAP or from the companion device;
determining that the at least one condition satisfies a trigger condition; and
scanning, by the device, to detect the WAP or the companion device at a non-standard frequency, based on the at least one condition satisfying the trigger condition, wherein the non-standard frequency is less frequent than a standard frequency.

2. The method of claim 1, wherein the trigger condition comprises the device being stationary associated with a predetermined threshold period of time.

3. The method of claim 2, further comprising:
determining the device is stationary based on at least the device being within an area defined by a geofence.

4. The method of claim 1, wherein the trigger condition comprises determining one or more time periods that the device historically lacks access to one or more WAPs based on usage patterns over time associated with the device.

5. The method of claim 1, wherein the trigger condition is based in part on the device moving at a threshold speed.

6. The method of claim 1, wherein the trigger condition comprises determining that one or more historical attempts, by the device, to connect to the WAP or one or more other WAPs were associated with connections to the WAP or the one or more WAPs associated with a time period equal to or below a predetermined time period.

7. The method of claim 4, wherein the trigger condition comprises determining that at least one connection, by the device, to the WAP or one or more WAPs comprise a signal strength below a predetermined threshold signal strength during a time period associated with a historical time period.

8. The method of claim 1, further comprising:
detecting the trigger condition by determining a battery power of the device being equal to or below a predetermined power threshold.

9. The method of claim 1, wherein the trigger condition comprises determining a temperature associated with the device equals or exceeds a predetermined thermal limit.

10. The method of claim 1, wherein the trigger condition comprises determining the device is in a location determined to lack one or more WAPs.

11. The method of claim 1, wherein the scanning, by the device, at the non-standard frequency which is less frequent than the standard frequency causes the device to utilize less power than an instance in which the device scans to detect the WAP at the standard frequency.

12. The method of claim 1, wherein the trigger condition comprises determining the device is in a location determined to comprise a prohibited WAP.

13. The method of claim 12, further comprising:
detecting, based on a scan by the device, the prohibited WAP, wherein the prohibited WAP prohibits the device to connect to the prohibited WAP.

14. A method facilitating wireless scanning with a first device, the method comprising:
connecting the first device to a companion device;
determining the first device is disconnected from a wireless access point (WAP);
determining at least one condition associated with the first device or with the companion device, based on the determining that the first device is disconnected from the WAP;
determining that the at least one condition satisfies a trigger condition; and
scanning, by the first device, to detect the WAP at a non-standard frequency, based on the at least one condition satisfying the trigger condition, wherein the non-standard frequency is less frequent than a standard frequency.

15. The method of claim 14, wherein the trigger condition comprises determining the first device is stationary associated with a predetermined threshold period of time.

16. The method of claim 15, further comprising:
detecting the trigger condition by determining a battery power of the first device equals or is below a predetermined power threshold.

17. The method of claim 14, wherein the scanning, by the first device, at the non-standard frequency which is less frequent than the standard frequency causes the first device to utilize less power than an instance in which the first device scans to detect the WAP at the standard frequency.

18. An apparatus comprising:
one or more processors; and
at least one memory storing instructions, that when executed by the one or more processors, cause the apparatus to:
determine that the apparatus is disconnected from a wireless access point (WAP) or from a companion device;
determine at least one condition associated with the apparatus, based on the determine that the apparatus is disconnected from the WAP or from the companion device;
determine that the at least one condition satisfies a trigger condition; and
scan to detect the WAP or the companion device at a non-standard frequency, based on the at least one condition satisfying the trigger condition, wherein the non-standard frequency is less frequent than a standard frequency.

19. The apparatus of claim 18, wherein when the one or more processors further execute the instructions, the apparatus is configured to:
perform the scan at the non-standard frequency which is less frequent than the standard frequency causing the apparatus to utilize less power than an instance in which the apparatus scans to detect the WAP at the standard frequency.

20. The apparatus of claim 18, wherein when the one or more processors further execute the instructions, the apparatus is configured to:
detect the trigger condition by determining a battery power of the apparatus being equal to or below a predetermined power threshold.
